(19) United States
(12) Patent Application Publication
(10) Pub. No.: US 2025/0311659 A1
(43) Pub. Date: Oct. 9, 2025

(54) STRUCTURES AND METHOD OF FERTILIZING TREES

(71) Applicant: University of Florida Research Foundation, Inc., Gainesville, FL (US)

(72) Inventors: Mica F. McMillan, Gainesville, FL (US); Karen Williams, Gainesville, FL (US)

(21) Appl. No.: 19/169,347

(22) Filed: Apr. 3, 2025

Related U.S. Application Data
(60) Provisional application No. 63/574,352, filed on Apr. 4, 2024.
(60) Provisional application No. 63/672,737, filed on Jul. 18, 2024.

(51) Int. Cl. A01C 21/00; A01G 7/06

(52) U.S. Cl. CPC A01C 21/00; A01G 7/06

(57) ABSTRACT

The present disclosure is directed to structures and methods of supplying materials such as fertilizers or pesticides to a tree, e.g., a palm tree. The structure can include an effective amount of material (e.g., a fertilizer) to treat (e.g., fertilize) the tree for a period time (e.g., week to 3 to 6 months or more). The present disclosure can be advantageous in that the material (e.g., fertilizer) is directly provided to the area of the palm tree that needs the material (e.g., fertilizer).

### CROSS-REFERENCE TO RELATED APPLICATIONS

This application claims the benefit of: U.S. Provisional Patent Application No. 63/574,352 filed on Apr. 4, 2024 and U.S. Provisional Patent Application No. 63/672,737 filed on Jul. 18, 2024, each of which is incorporated herein by reference in its entirety.

### BACKGROUND

Palm trees are typically fertilized using slow-release granular palm fertilizer that are spread at the base of the palm tree. However, fertilizing palm trees in this way can lead to overapplication of fertilizers as well as confusion over landscape/turf plant fertilizer that may interfere with the specific nutrient requirements of palm trees. In addition, applying fertilizer on the ground around the palm tree can result in the runoff of the fertilizer and/or leaching of fertilizers. Thus, there is a need to more effectively and efficiently fertilize palm trees.

### SUMMARY

The present disclosure is directed to structures and methods of supplying materials such as fertilizers or pesticides to a tree.

In an aspect, the present disclosure provides for a method of fertilizing a palm tree, comprising: providing a structure comprises a fertilizer, wherein the structure has dimensions to fit around at least part of a spear leaf of a palm tree, and disposing the structure around at least a part of the spear leaf of the palm tree, wherein when the structure is exposed to water, the structure is designed so that the fertilizer is released from the structure and travels to the apical meristem of the palm tree.

In an aspect, the present disclosure provides for a method of treating a palm tree, comprising: providing a structure comprises a material, wherein the structure has dimensions to fit around at least part of a spear leaf of a palm tree, and disposing the structure around at least a part of the spear leaf of the palm tree, wherein when the structure is exposed to water, the structure is designed so that the material is released from the structure onto the palm tree and/or into the apical meristem of the palm tree.

In an aspect, the present disclosure provides for a structure, comprising a structure configured to fit around at least part of a spear leaf of a palm tree, wherein the structure is configured to include a material, wherein the structure is configured to include an amount of material to be released onto the palm tree for a period of time.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A illustrates a sketch of a portion of a palm tree.

FIG. 1B illustrates a sketch of a portion of the unopened palm spear.

FIG. 2 illustrates a sketch of an embodiment of the structure that can be filled with a material such as a fertilizer, pesticide, or a combination thereof.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of chemistry, medical imaging, biochemistry, pharmacology, medicine, and the like, which are within the skill of the art. Such techniques are explained fully in the literature.

Prior to describing the various embodiments, the following definitions are provided and should be used unless otherwise indicated.

Unless otherwise defined, all technical and scientific terms used herein have the same meaning as commonly understood by one of ordinary skill in the art of microbiology, molecular biology, medicinal chemistry, physical chemistry, and/or organic chemistry. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DISCUSSION

Embodiments of the present disclosure are directed to structures and methods of supplying materials such as fertilizers or pesticides to a tree, e.g., a palm tree. The structure can include an effective amount of material (e.g., a fertilizer) to apply the material or treat (e.g., fertilize) the tree for a period time (e.g., week to 3 to 6 months or more). The present disclosure can be advantageous in that the material (e.g., fertilizer) is directly provided to the area of the palm tree that needs the material (e.g., an apical meristem of the palm). The present disclosure provides an efficient and direct way to deliver fertilizer. In another embodiment, the present disclosure provides an efficient and direct way to deliver a pesticide.

In an aspect, the structure can be made of a biodegradable (e.g., so after use, the structure does not harm the environment), permeable (e.g., so that water, irrigation or rainfall can mix with the material (e.g., fertilizer) and flow the material down the spear leaf of a palm tree, for example), and/or expandable material (e.g., so that the structure can fit onto different sized spear leaves and along different areas along the length of the spear leaf). In an aspect, the structure is specifically designed (e.g., dimensions and including a hole so the structure can fit around the spear leaf) to fit around at least a part of the spear leaf of a palm tree and when it is watered (e.g., rain water, sprinkler water, etc.), the material (e.g., fertilizer) will move directly (e.g., flow) into the apical meristem of the palm.

In an aspect, the material can be directly applied to the material of the structure. When water contacts (e.g., rain, sprinkler, hose, etc.) the structure, the material can flow from the structure to the tree. In another aspect, the structure can include a container that holds the material. In an aspect, the container can be made of a water permeable material so that when in contact with water, the water can contact the material and allow for the material to flow out of the container. The material can be added to the container and then sold to a supplier or end user, while in another aspect, the material can be added to the container by the end user (e.g., arborist). The container is designed so that upon contacting water (e.g., rain, sprinkler, hose), the material is released and flows onto the tree.

In an aspect, the material can be a fertilizer, a pesticide, or a combination thereof. In an aspect, the structure can include other materials other than the fertilizer such as biochar, compost, or the like, where the other material(s) can include nutrients that the palm tree can utilize. For example, compost that includes kenaf can be used, and the kenaf is high in potassium and magnesium, which are nutrients the palm needs.

In an aspect, the fertilizer can include a soluble or slow-release prill technology (8-2-12+4, 0-0-22+4, 0-0-16+4, 15-0-15, etc. and is dependent upon end-user preference and nutritional deficiencies and/or insect/fungal damage.

In an aspect, the pesticide can include imidacloprid, bifenthrinm, etc.

The nutrient status of palm trees can be difficult to determine due to lack of frond nutrient analyses data and the variability between palm species. However, data collection on palm trees is not an easy task due to height of the palm trees, removal of fronds that influence photosynthesis, nutrient distribution and the extensive response time for fertilizer applications to be visually evident. Continuously sacrificing fronds for nutrient analyses on slow growing palms delays growth and may lead to death. Drones have been used in other agricultural crops to determine nutrient status and plant health. However, drone use in palm trees to determine nutrient status has not been attempted. In an aspect, drones can be used to determine the nutrient status of palm trees, can be used to apply structures to palm trees, and can be used to monitor the nutrient status of palms trees once the structure is applied to the palm tree. Drones (and computers systems in communication with the drones or on-board the drones) used in palm trees analysis can use methods to determine the I/O plant health ratio which can be compared to determining Normalized Difference Vegetative Index or NDVI. Drone imagery can be used to determine green canopy or lack thereof and weakened areas in the palm canopy—both top and profile views into the canopy.

In an aspect, the structure is designed to have dimensions so that the structure can fit around (e.g., slide down the length of the spear leaf through an opening in the structure and/or include an opening (e.g., slit opening or “C” opening) in the side of the structure so the structure can fitted directly to a specific region of the spear leaf without the need for sliding down the length of the spear leaf). In an aspect, the structure includes an opening (e.g., hole) in the middle region of the structure so that the structure can be slide down the length of the spear leaf. Since the spear leaf is the newest palm leaf and is a stiff frond that stands upright, the structure can be slide down the length of the spear leaf. When the structure is exposed to water and/or temperature (e.g., rainwater, sprinkler water, summer heat, etc.), the structure is designed so that the material (e.g., fertilizer) is released from the structure (or container within the structure) and travels to the apical meristem of the palm tree so that the fertilizer (or other material) dissolves around the bud of the palm. In particular, this direct approach to fertilizing the palm tree avoids the potential for overapplication of fertilizers or applying the incorrect type of fertilizer to the palm tree so that the correct fertilizer can be applied to address the specific nutrient requirements of palm trees. In an aspect, an arborist can apply to the structure of the palm tree during the pruning process.

In an aspect, the present disclosure provides for methods of applying a material to a palm tree or treating a palm tree. The method can include providing a structure comprising a material (e.g., fertilizer, pesticide, and the like). The structure has dimensions to fit around at least part of a spear leaf of a palm tree. The method includes disposing the structure around at least a part of the spear leaf of the palm tree, where when the structure is exposed to water, the structure is designed so that the material is released from the structure onto the palm tree. The material can be released over a time period of weeks to years (e.g., about 1 week to 5 years, about 1 week to 2 years, about 1 week to 1 year, about 1 week to 6 months, about 1 week to 3 months, or about 1 week to 1 month).

In a particular aspect, the present disclosure provides for methods of fertilizing a palm tree and monitoring the palm tree using drone technology. The method of fertilizing the palm tree can include providing a structure, such as those described herein, that includes an effective amount of fertilizer to fertilize the palm tree for a period of time. The method includes disposing the structure around at least a part of the spear leaf of the palm tree. When the structure is exposed to water, the structure is designed so that the fertilizer is released (e.g., slow release or sustained release) from the structure and travels to the apical meristem of the palm tree. In an aspect, the structure can be a scrunchie or scrunchie-like structure that can be slide down the length of the spear leaf. The effective amount of the fertilizer can be an amount that can fertilize the palm tree for about a week to 3 months or 6 months. In another aspect, the method can be used to apply a pesticide and the effective amount can last a week to years.

Now having described the structure and method generally, additional details are provided below. In an aspect, the present disclosure provides a structure configured to fit around at least part of a spear leaf of a palm tree. While the material can be a fertilizer or a pesticide, some of the following discussion is directed to a fertilizer, but the present disclosure is not limited to only a fertilizer.

In an aspect, the structure comprises a fertilizer in an amount effective to fertilize the palm tree for a period of time (e.g., 1 week to 6 months). The structure can have a substantially circular cross-section that fits around at least part of the spear leaf. The structure includes an opening in the middle region and/or an opening (e.g. slit or “C” opening) so that the structure can be placed around at least part of the spear leaf. In an aspect, the three-dimensional structure can have a ring torus shape or substantially (e.g., about 70% or more) a ring torus shape, where the structure having the ring torus shape or substantially the ring torus shape is configured to slide down the length of the spear leaf or include a slit opening (“C” opening) in the side of the structure to apply the structure to the spear leaf.

In an aspect, the opening can have a dimension (e.g., diameter) that can vary if the structure is flexible or expandable, or the dimension can be set if the structure is rigid. In an embodiment, the opening for structures that are flexible or expandable can be about 1 cm to 100 cm, where the opening dimensions can increase or decrease in size to fit dimensions (e.g., diameter) of the spear leaf. In another embodiment where the structure is rigid, the opening can have a dimension of about 10 cm to 100 cm or about 10 cm to 500 cm. The dimension of the structure from the inner wall (e.g., adjacent the hole opening) to the outer wall of the structure can be about 10 to 500 cm, while the height or thickness of the scrunchie can be about 10 to 500 cm. The dimensions can be selected based on the three-dimensional features of the structure, which can be selected based on the amount of fertilizer to include in the structure and/or the time period to fertilize the palm tree.

The structure can be made of biodegradable materials. These materials can include fabrics, polymers, hydrogels, natural products (e.g., plant-based materials), and combinations thereof. The fertilizer can be incorporated into the structure using separate container (e.g., packet(s) or pouch(es) of material such a fertilizer and/or infusing the materials used to make the structure with the fertilizer. The structure and/or the packages including the fertilizer can be designed so that the fertilizer is released over time. For example, only a select amount of the fertilizer can be released each time the structure is exposed to water. In an aspect, the structure can include an indicator (e.g. a color indicator (e.g., changes color as the fertilizer is released)) so that the amount of fertilizer can be monitored over time (e.g., using a drone or other imaging system).

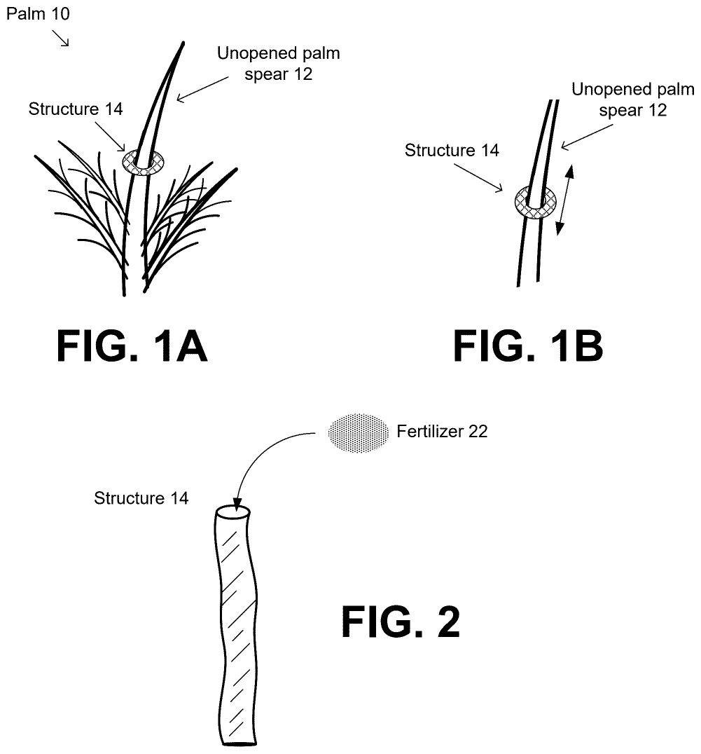

In an aspect, the structure can be a “scrunchie” (e.g., that includes fertilizer such as a fertilizer container or pouch) around a section of a spear leaf of a palm tree (See FIG. 1A). While the term “scrunchie” is typically referred to as a fabric elastic hair tie for long hair, the term “scrunchie” referred to herein is similar in that the scrunchie can be elastic so it can be slide down the spear leaves of differing sizes, but the scrunchie can be made of biodegradable material and designed to include fertilizer. The fertilizer can be included in one or more containers (e.g., packages or pouches) within the scrunchie and/or the material used to make the scrunchie can be infused with the fertilizer. The scrunchie can be made of fabrics, polymers, and/or natural materials that are not harmful to the palm tree or the environment. In an aspect, the scrunchie can have an opening (e.g., hole) in the middle region so that the scrunchie can be placed around the spear leaf. The opening can have a variable dimension (e.g., diameter) (e.g., about 1 cm to 100 cm) that can increase or decrease in size to fit dimensions (e.g., diameter) of the spear leaf. The dimension of the scrunchie from the inner wall (e.g., adjacent the hole) to the outer wall of the scrunchie can be about 10 to 500 cm, while the height or thickness of the scrunchie can be about 10 to 500 cm. The dimensions can be selected based on the spear leaf dimensions, the amount of fertilizer to be applied, the time frame to apply fertilizer, and the like. The scrunchie can slowly release (e.g., a week to 3 or 6 months) fertilizer directly to the apical meristem to feed the palm tree. In an aspect, the scrunchie is designed to release the fertilizer when exposed to water (e.g., rain, dew, controlled watering (e.g., sprinkler), or a combination thereof).

A replicated field trial to compare fertilization techniques on Christmas palm trees (Adonidia merrilleii) and to determine if multispectral imaging can accurately depict the nutrient status of lower and upper canopy fronds by comparing frond nutrient analyses. Palm trees will be planted at Fort Lauderdale Research and Education Center in native south Florida soil and irrigated as needed to facilitate establishment. Treatments will include standard fertilization practices as well using structures of the present disclosure. Fertilization rates will be determined by labeled rates and frequency. Prior to fertilizer treatment and thereafter as designated by the protocol the following data will be collected: soil moisture, soil analyses, palm height, quality ratings, total frond count, frond nutrient analyses and chlorophyll status. Multispectral imaging will be captured prior to treatment application and thereafter every two-three months based on frond turnover. Treatments will be compared to assess the most efficacious.

FIG. 1A illustrates a sketch of a portion of a palm tree 10. The structure 14 can be placed onto the unopened palm spear 12. FIG. 1B illustrates a close-up sketch of a portion of the unopened palm spear 12, where the arrows indicate that the structure 12 can be slide to an appropriate position along the unopened palm spear 12. Over time the structure 14 is exposed to water and/or temperature (e.g., rainwater, sprinkler water, summer heat, and/or combinations thereof), where the structure 14 is designed to release fertilizer that can travel to the apical meristem of the palm tree and dissolve around the bud of the palm. FIG. 2 illustrates an embodiment of the structure 14 that can be filled with a material 22 such as fertilizer, pesticides, or a combination thereof. The material 22 can be added to the structure 14 prior to shipping to the retailer or buyer or the material 22 can be added to the structure 14 by the retailer or buyer (e.g., arborist).

Additional studies provided the following data. Due to the lack of moisture and extremely droughty conditions, soil applied fertilizer pathways to the palm tree can be affected by volatilization and a failure to reach roots due to lack of moisture as well as hydrophobic soils. Despite this, when rainfall occurs, even minimal rainfall, the release of fertilizer is directed at the apical meristem that may provide direct uptake and utilization by the palm tree. A field trial was conducted at Fort Lauderdale Research and Education Center to determine the best method to fertilize Christmas palms (Adonidia merrillei) that were planted on low organic matter sand soil that had little to no water holding capacity. Fertilizer methods were as follows: 1) Untreated 2) Palm Special 8-2-12+4, 4 x/yr 3) Sul-Po-Mag 0-0-22+4, 4x/yr 4) Apical Meristem Injection (1x/yr) 5) structure of the present disclosure (1x/yr) and 6) Injections (1x/yr). Based on preliminary data, the structure of the present disclosure using apical meristem treatment showed the best overall quality with the untreated control having the lowest quality. For palm trees, two-three year studies are required to assess treatment effects due to slow growth and canopy turnover.

TABLE 1
Visual Quality Ratings, Jan 2024- April 2025

| TREATMENT | JANUARY | FEBRUARY | MARCH | APRIL | MAY | JUNE | JULY | AUGUST |
|---|---|---|---|---|---|---|---|---|
| Palm Special | 7.1a | 6.4bc | 6.5ab | 6.5b | 6.4 | 6.6ab | 6.4ab | 7.2 |
| Injection | 6.4b | 6.4bc | 6.5ab | 6.3bc | 6.6 | 6.5ab | 6.7ab | 6.7 |
| Sul-Po-Mag | 6.8ab | 6.8ab | 6.9ab | 6.8ab | 6.5 | 6.3ab | 6.9a | 7.0 |
| Structure of | 7.0ab | 7.7a | 7.5a | 7.6a | 6.7 | 7.0a | 7.2a | 7.0 |
| the present | | | | | | | | |
| disclosure* | | | | | | | | |
| AMD | 7.0ab | 6.4bc | 6.5ab | 7.0ab | 6.6 | 6.8ab | 6.8ab | 7.0 |
| Untreated | 6.8ab | 6.2c | 6.0b | 5.4c | 6.0 | 6.1b | 6.1b | 6.3 |
| SIGNIF. | + | + | + | ** | ns | + | + | ns |

| TREATMENT | JANUARY | FEBRUARY | MARCH | APRIL |
|---|---|---|---|---|
| Palm Special | 7.0ab | 6.6a | 6.5a | 6.7a |
| Injection | 7.0ab | 6.9a | 6.4a | 6.3ab |
| Sul-Po-Mag | 7.0ab | 7.1a | 6.4a | 6.4ab |
| Structure of the | 7.1a | 7.0a | 6.8a | 6.7a |
| present disclosure* | | | | |
| AMD | 6.9ab | 6.8a | 6.4a | 6.1ab |
| Untreated | 6.3b | 6.0b | 5.3b | 5.1b |
| SIGNIF. | + | * | * | + |

ns, +, *, **, and *** = P > 0.10, P < 0.10, P < 0.05, P < 0.01 and P < 0.001
Rating scale of 1-9 where 9 = best, 6 = minimally acceptable and 1 = dead palm
Ratings were taken every 2 weeks and combined for a monthly average. All palms were above the minimally acceptable rating of 6.
Please note that these palms were maintained under deficit irrigation conditions where no supplemental irrigation was applied. Volumetric water content was typically below 10%.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

1. A method of fertilizing a palm tree, comprising:
providing a structure comprises a fertilizer, wherein the structure has dimensions to fit around at least part of a spear leaf of a palm tree, and
disposing the structure around at least a part of the spear leaf of the palm tree, wherein when the structure is exposed to water, the structure is designed so that the fertilizer is released from the structure and travels to the apical meristem of the palm tree.

2. The method of claim 1, wherein the structure has a substantially circular cross-section that fits around at least part of the spear leaf.

3. The method of claim 1, wherein the structure is a scrunchie, wherein the scrunchie fits around the spear leaf, wherein the scrunchie is configured to slide down the length of the spear leaf.

4. The method of claim 1, wherein the structure has a ring torus shape or substantially a ring torus shape, optionally wherein the structure having the ring torus shape or substantially the ring torus shape is configured to slide down the length of the spear leaf.

5. The method of claim 1, wherein the structure is biodegradable.

6. The method of claim 1, wherein the structure has an opening in the middle region of the structure and has a dimension so that the structure fits around at least part of the spear leaf.

7. The method of claim 6, wherein the dimension of the middle region is about 1 cm to 100 cm.

8. The method of claim 6, wherein the structure has a length from the opening in the middle to an outer edge of the structure, wherein the length is about 10 cm to 500 cm.

9. The method of claim 1, wherein the structure has an amount of fertilizer that is effective to fertilize the palm tree for a period of time, optionally wherein the period of time is about 1 week to 3 months.

10. A method of treating a palm tree, comprising:
providing a structure comprises a material, wherein the structure has dimensions to fit around at least part of a spear leaf of a palm tree, and
disposing the structure around at least a part of the spear leaf of the palm tree, wherein when the structure is exposed to water, the structure is designed so that the material is released from the structure onto the palm tree.

11. The method of claim 10, wherein the material is selected from a fertilizer or a pesticide.

12. The method of claim 10, wherein the structure has a ring torus shape or substantially a ring torus shape, optionally wherein the structure having the ring torus shape or substantially the ring torus shape is configured to slide down the length of the spear leaf.

13. The method of claim 10, wherein the structure has an amount of material to release for a period of time, optionally wherein the period of time is about 1 week to 3 months or optionally the period of time is 1 week to 2 years.

14. A structure, comprising a structure configured to fit around at least part of a spear leaf of a palm tree, wherein the structure is configured to include a material, wherein the structure is configured to include an amount of material to be released onto the palm tree for a period of time.

15. The structure of claim 14, wherein the structure includes a container configured to hold the material.

16. The structure of claim 14, wherein container includes the material, wherein the material is selected from a fertilizer or a pesticide.

17. The structure of claim 16, wherein the structure comprises the fertilizer, wherein the structure includes an amount of fertilizer to fertilize the palm tree for a period of time, optionally wherein the period of time is about 1 week to 3 months.

18. The structure of claim 16, wherein the structure comprises the pesticide, wherein the structure includes an amount of pesticide to treat the palm tree for a period of time, optionally wherein the period of time is about 1 week to 2 years.

19. The structure of claim 14, wherein the structure has a ring torus shape or substantially ring torus shape, optionally wherein the structure having the ring torus shape or substantially the ring torus shape is configured to slide down the length of the spear leaf.

20. The structures of claim 14, wherein the structure has an opening in the middle region of the structure and has a dimension so that the structure fits around at least part of the spear leaf.
